(19) United States
(12) Patent Application Publication
(10) Pub. No.: US 2007/0140817 A1
(43) Pub. Date: Jun. 21, 2007

(54) Computer-controlled transport device

(76) Inventor: Rudolf Hansl, Linz (AT)

Correspondence Address: WILLIAM COLLARD;COLLARD & ROE, P.C., 1077 NORTHERN BOULEVARD, ROSLYN, NY, 11576, US

(21) Appl. No.: 10/592,992

(22) PCT Filed: Mar. 4, 2005
(86) PCT No.: PCT/AT05/00068

§ 371 Date: Jan. 19, 2007

(30) Foreign Application Priority Data
Mar. 15, 2004 (AT) A 458/2004

(51) Int. Cl. B65G 65/00

(52) U.S. Cl. 414/277

(57) ABSTRACT

The invention relates to a computer-controlled conveyor system, comprising a vertical mast (7), a displaceable lifting platform (5) disposed on it and a holding table (6) which can be vertically displaced relative to the latter. Disposed on the lifting platform (5) are two telescopic pushing arms (33) which can be moved towards one another and moved apart from one another to a limited degree and which can be extracted in the direction of a shelf compartments for storing and retrieving the storage aids (30). In order to convey two storage aids (30) simultaneously, one is deposited on the holding table (6) and the other is deposited on the lifting platform (5). The holding table (6) has a lifting frame (46) in which an orifice (47) is provided, the length and width of which are bigger than the length and width of each of the telescopic pushing arms (33) retracted towards the lifting platform (5). The lifting frame (46) can be moved out of the transfer or handover position, lowered so as to be approximately flush with a horizontal support surface (31) of the lifting platform (5), into the conveying position, and when the holding table (6) is in the transfer or handover position, the two telescopic pushing arms (33) extend through a respective orifice (47).

The invention relates to a conveyor system, in particular shelf-stacking device, of the type outlined in the introductory parts of claims 1 and 5.

Document DE 299 21 514 U1 discloses a shelf-stacking device which can be moved between storage shelves, with a vertical mast which can be driven by means of a bogie assembly and is supported on a bottom guide track by means of two runner wheels. Displaceably guided on the mast in the vertical direction by means of a first lifting drive, on which a load-bearing mechanism is disposed in order to move storage aids, such as containers, boxes or similar into and out of a shelf compartment of the shelving system, is a lifting platform with a depositing area which has room to accommodate only one storage aid. By means of the load bearing mechanism, it is possible to approach the shelf compartment from two different depth positions, as a result of which the shelf aisle between the storage shelves is kept to a minimum, whilst maximizing the standing room available for the storage shelves. To enable two storage aids to be handled by the shelf-stacking device simultaneously, a holding table is additionally provided on the lifting platform, which can be raised and lowered vertically relative to it by means of a second lifting drive. The holding table is supported on a linear guide extending parallel with the mast which, like the second lifting drive, is disposed on the lifting platform. By means of the holding table, a first storage aid is lifted far enough to enable a second storage aid to be conveyed on the lifting platform unhindered and deposited or retrieved.

Patent specification DE 695 12 309 T2 also discloses a shelf-stacking device for picking up sheets of paper packed in a ream and comprises a rectangular conveyor frame with a lifting platform between its vertical masts which can be moved in the vertical direction, and the conveyor frame is guided on a bottom and top guide track an can be driven by means of bottom and top bogie assemblies. The lifting platform is attached to two lifting frames (103), each of which can be displaced vertically along the masts, and is provided with a pick-up, holding and pulling mechanism (D) for lifting, holding and pulling out the stacked ream from the storage shelf on the one hand, and a discharging and stacking mechanism (E) for removing the extracted ream, transferring and stacking it on a pallet (109) on the other hand. The pallet (109) is disposed on a telescopic fork mechanism (106) underneath the pick-up, holding and pulling mechanism (D) and is held in position relative to the transfer and stacking mechanism (E). The fork mechanism (106) is disposed on a pallet manipulating device (C), which is also mounted on the lifting frame (103) and can be vertically displaced relative to the lifting platform.

The underlying objective of the present invention is to propose an improved, computer-controlled conveyor system, which operates reliably and is distinctive due to the fact that it offers a high degree of flexibility in terms of storing storage aids and is of a simple construction.

This objective is achieved by the invention on the basis of the features defined in the characterizing part of claim 1. The surprising advantages gained as a result are the fact that the storage system does not have to be restricted to a single type of storage aid to be stored and retrieved, with identical external dimensions in terms of length/width, and instead, storage aids of differing external dimensions can be manipulated by means of the load bearing mechanism, thereby making the storage facilities extremely flexible. Furthermore, the lifting platform and the holding table are of only a narrow design, so that there is room for only one storage aid as viewed in the direction perpendicular to the longitudinal extension of the shelf aisle, as a result of which the shelf aisle is of a minimal width, whilst the room available for the storage shelves is maximized. Another advantage is the fact that the holding table is sufficiently rigid but has a minimal intrinsic weight, which means that a drive motor with a low driving power can be used, thereby enabling the displacement properties such as acceleration and driving speeds to be improved. Furthermore, if a storage aid is pushed onto the lifting platform but is out of line, the storage aid is reoriented and centered on the lifting platform by means of the telescopic pushing arms which can be displaced relative to one another to a limited degree. This reliably eliminates the risk of a storage aid being out of line when this storage aid is transferred from the lifting platform onto the holding table or is being deposited in a shelf compartment, for example.

The embodiment defined in claim 2 is also of advantage because the overall construction of the shelf-stacking device is made simpler due to the construction of the lifting frame of the holding table proposed by the invention.

The embodiment defined in claim 3 offers an optimal compromise between the load bearing capacity of the lifting frame and flexibility in manipulating storage aids of differing external dimensions. When the holding table is in the lowered transfer or handover position, the mutually separate orifices of the telescopic pushing arms are held but the telescopic pushing arms can still be displaced transversely to their longitudinal extension without colliding with the holding table.

The telescopic pushing arms are exactly guided as a result of the embodiment defined in claim 4.

The objective of the invention is also achieved on the basis of the features defined in the characterizing part of claim 5. The advantage of this approach is that the intrinsic weight of the lifting platform is reduced, which relieves the load of at least one guide track on the mast and the guide members on the lifting platform, whilst reducing the structural height of the lifting platform. This results in particularly conducive conveying properties, such as high start-up accelerations and travel speeds of the lifting platform and a high load-bearing capacity. The combination of the two inventions, namely the mutual displacement of the telescopic pushing arms transversely to the longitudinal extension, on the one hand, and the improved conveying properties of the lifting platform on the other hand, results in a shelf-stacking device which is distinctive due to its high flexibility, particularly due to the fact that it can be adapted to operate under very varied conditions. This conveyor system and in particular this shelf-stacking device is especially suitable for use in warehouses handling small components, in which active loads of up to approximately 50 kg are conveyed and the bottom and top approach distance to the shelf compartments in the vertical direction must be maintained.

Advantageous designs of the drive means and the driver and their embodiments are described in claims 6 to 9.

Also of advantage is the embodiment defined in claim 10 with the simple transmission of the driving force to the holding table.

The advantage of the embodiment defined in claim 11 is that neither the lifting platform nor the holding table have to bear the weight of the drive motor of the second lifting drive, which in turn has a positive effect on the conveying properties of the lifting platform and holding table mentioned above. Moreover, installation of the lifting platform and holding table is made simpler.

As a result of the embodiment defined in claim 12, the maximum travel path of the holding table is limited and the risk of collision with the lifting platform or damage to the second lifting drive is effectively avoided.

Claim 13 describes an advantageous embodiment of the second lifting drive.

The different control options defined in claims 14 and 15 enable a positioned movement of the holding table relative to the lifting platform on the one hand, whilst on the other hand, the holding table and lifting platform can be moved synchronously at a fixed distance with respect to one another (corresponding to the travel path) into a desired position pre-defined by the computer system as the conveyor system, in particular the shelf-stacking device is being moved along the shelf aisle. However, in order to make the shelf-stacking device even more efficient in terms of the cycle times needed to deposit and retrieve storage aids, both the holding table and the lifting platform can be displaced relative to one another as the conveyor system is being moved.

The improved embodiments defined in claims 16 to 18 are of advantage because the holding table and optionally also the lifting platform can be maintained in their corresponding positions and can be so as the conveyor system, in particular the shelf-stacking device, is being moved along the shelf aisle, so that the storage aids are reliably supported by the lifting platform on the one hand and by the holding table on the other hand.

As a result of the preferred embodiments defined in claims 19 and 20, an additional traction drive is not needed as a second lifting drive. For the purpose of the invention, the traction means of the first lifting drive for the lifting platform can be fitted around a second drive gear of the so-called Omega drive and the holding table can be vertically displaced by the driven, second drive gear along the strand of the traction means pulled between the lifting platform and the first guide pulley mounted at the mast head. Since the drive motor of the second lifting drive is disposed separately from the lifting platform, the intrinsic weight of the lifting platform is reduced. This also reduces the cost of producing the lifting platform.

The embodiment defined in claim 21 is also of advantage because exclusively the third drive and guide pulleys of the second lifting drive are disposed on the holding table and the endlessly circulating traction means of an auxiliary drive are guided around the third drive and guide pulleys, which means that no additional supports for tensioning means, mounting elements for tension means and such like have to be provided on the holding table. The auxiliary drive is offset to the side, adjacent to the first lifting drive on the mast. This free space adjacent to the first lifting drive is available anyway, which means that the shelf-stacking device does not have to be made wider. This results in a particularly compact arrangement in the vertical direction and an approach distance in the vertical direction can be kept short enabling the uppermost shelf positions of a shelf compartment to be approached without difficulty.

An advantageous guide concept of the holding table is described in claim 22.

The advantage of claim 23 is that the linear guide for the holding table is disposed separately from the load-bearing means, thereby reducing the intrinsic weight of the lifting platform.

Another embodiment of the invention is defined in claim 24. The advantage of this approach is that the at least one guide track on the mast for the lifting platform simultaneously serves as a linear guide for the holding table which significantly simplifies the overall construction as a result.

One possible embodiment of the lifting frame of the holding table is defined in claim 25.

The advantage of the embodiments defined in claims 25 to 30 is that they result in a lightweight construction, thereby reducing the dynamic stress to which the mast is undesirably exposed. A particularly dimensionally stable design of the holding table is described in claim 27. The design of the holding table defined in claim 28 is also of advantage because it enables different length variations of the traction means of the first lifting and auxiliary drive and optionally enables the associated inaccurate positioning of the holding table with respect to the lifting platform to be compensated. The lifting grill may be separated from the lifting frame in the transfer or handover position. This being the case, the lifting grill is supported on the lifting platform, whilst the lifting frame can be moved down even further away from the lifting platform if necessary. When the holding table is raised into the conveying position, the lifting grill is in turn lifted off the lifting platform and the coupling parts engaged.

The embodiments defined in claims 31 and 32 are also of advantage due to the fact that they are of a simple construction and inexpensive to produce.

As defined in claims 33 and 34, the support bars of the lifting grill can be moved unhindered down into the spaces between the support surfaces of the support frame or the endless conveyors. The design defined in claim 34 is of particular advantage because, at a storage or retrieval point in the upstream zone, the storage aids deposited on the lifting platform can be discharged by means of the longitudinal conveyor system to a discharge system disposed downstream of it in the conveying direction, in particular a driven conveyor system, without having to extract the telescopic pushing arms. Furthermore, storage aids of small external dimensions (length/width) can also be reliably conveyed.

Also of advantage is the embodiment defined in claim 35, whereby the conveyor system can be adapted to specific applications.

Finally, as defined in claim 36, a significant saving on cycle time can be achieved when discharging and picking up storage aids at a storage and retrieval point in the upstream zone at the end of the shelf aisle. To this end, the lifting platform is retained in a desired position pre-defined by a computer system and the holding table is retained at a fixed distance relative to the lifting platform (corresponding to the travel path) and the first storage aid deposited or to be deposited on the holding table can be manipulated by means of a filling and pick-up system in the upstream zone, in particular a ram, and the second storage aid deposited or to be deposited on the lifting platform can be manipulated simultaneously by means of the load bearing mechanism, in particular can be lifted off the lifting platform or off the holding table or pushed onto the lifting platform or holding table.

The invention will be explained in more detail below with reference to examples of embodiments illustrated in the appended drawings.

Of these:

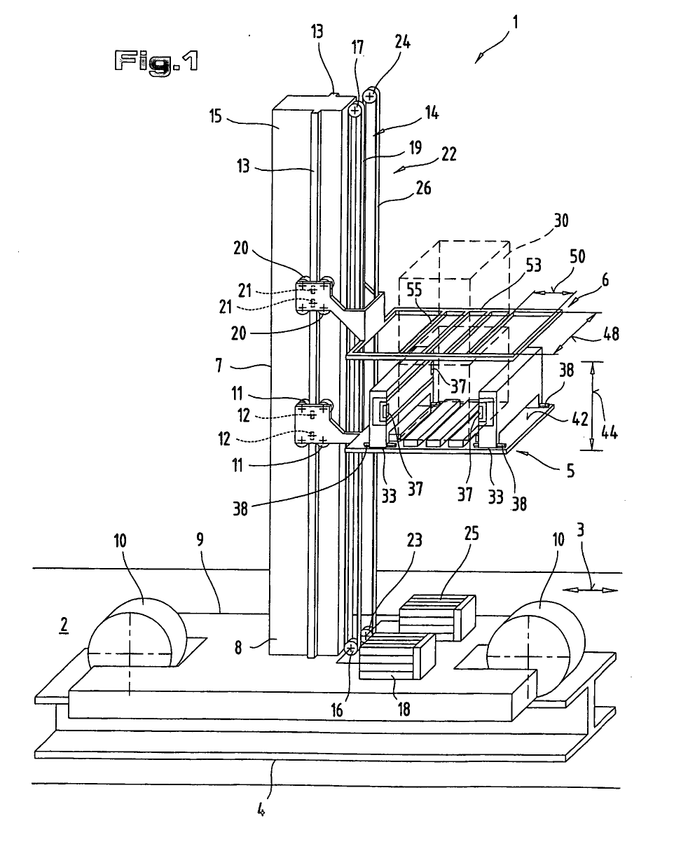

FIG. 1 is a simplified diagram showing a perspective view of the conveyor system proposed by the invention, in particular a shelf-stacking device incorporating the lifting platform, with the holding table raised into the conveying position and a first embodiment of a second lifting drive for the holding table;

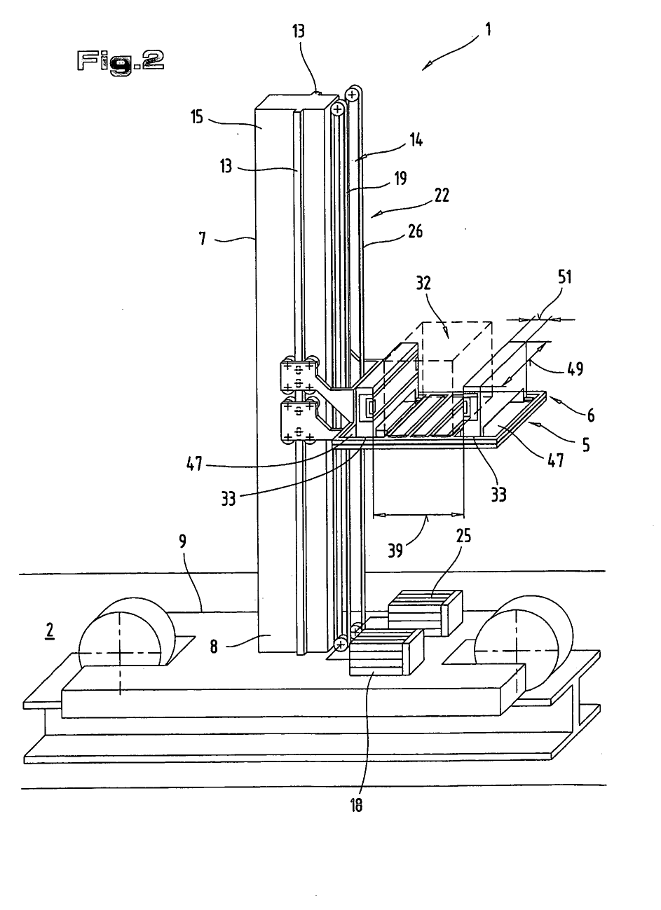

FIG. 2 is a schematic diagram showing a perspective view of the conveyor system illustrated in FIG. 1 incorporating the lifting platform and with the holding table lowered into the transfer or handover position;

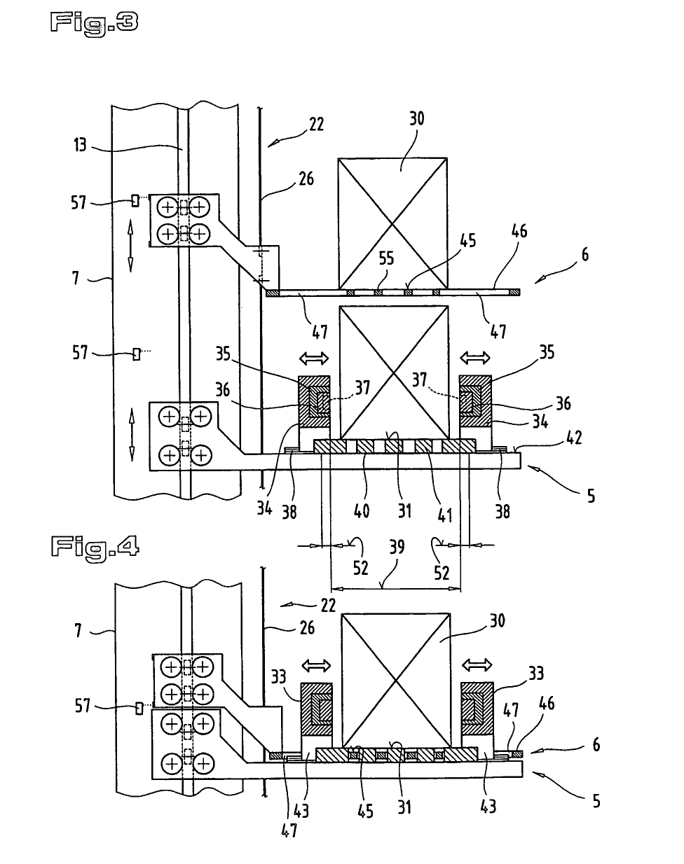

FIG. 3 is a simplified diagram showing a part-region of the conveyor system illustrated in FIG. 1 in partial section;

FIG. 4 is a schematic diagram view in partial section, showing a part-region of the conveyor system illustrated in FIG. 2;

FIG. 5 is a schematic diagram in partial section showing a side view of a part-region of the conveyor system proposed by the invention incorporating the lifting platform, with the holding table raised into the conveying position and another embodiment of the second lifting drive for the holding table;

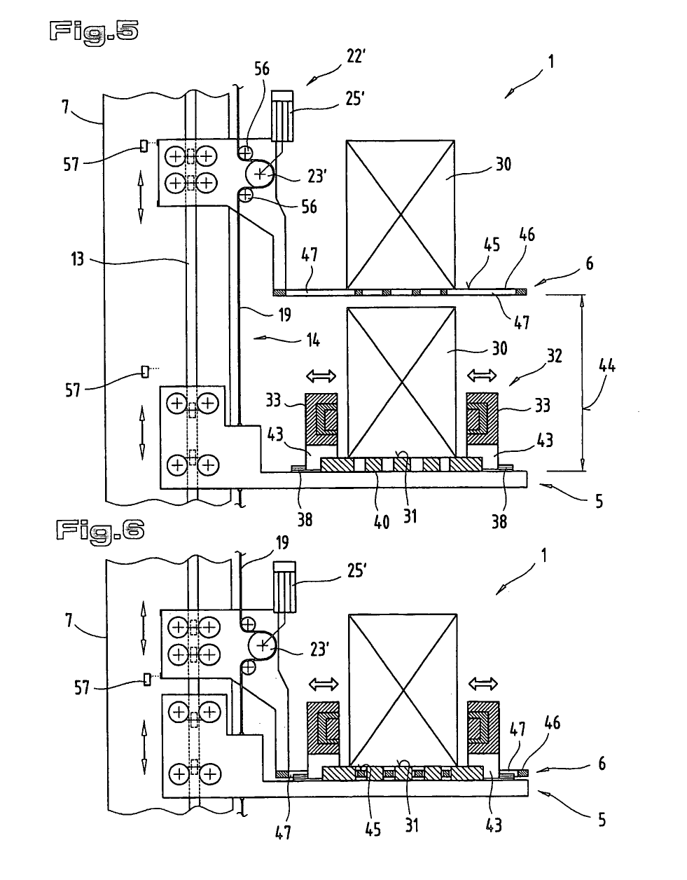

FIG. 6 is a schematic diagram in partial section showing a side view of a part-region of the conveyor system illustrated in FIG. 5 incorporating the lifting platform and with the holding table lowered into the transfer or handover position;

FIG. 7 is a schematic diagram in partial section showing a side view of a part-region of the conveyor system proposed by the invention illustrated in FIG. 5 with a different embodiment of the linear guide for the holding table;

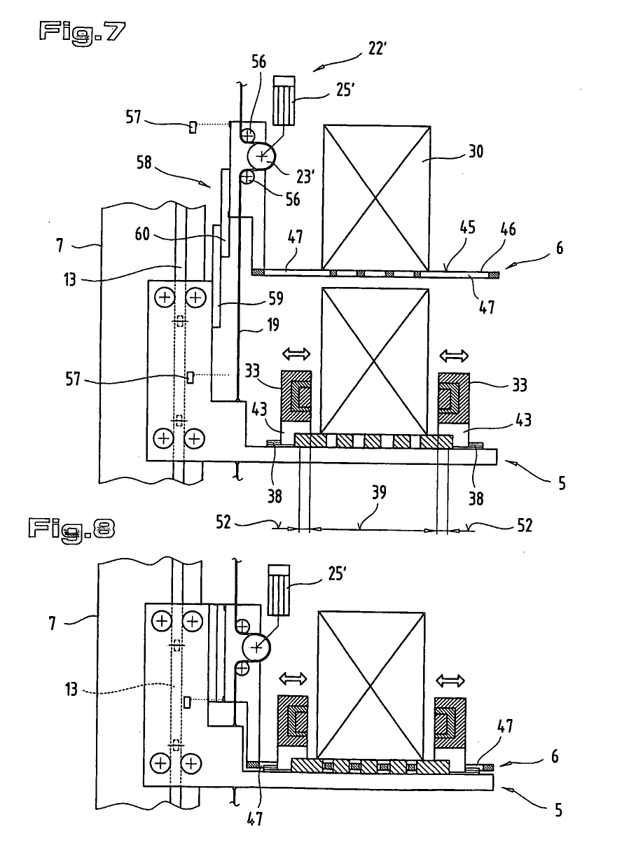

FIG. 8 is a schematic diagram in partial section showing a side view of a part-region of the conveyor system proposed by the invention illustrated in FIG. 7, incorporating the lifting platform and with the holding table lowered into the transfer or handover position;

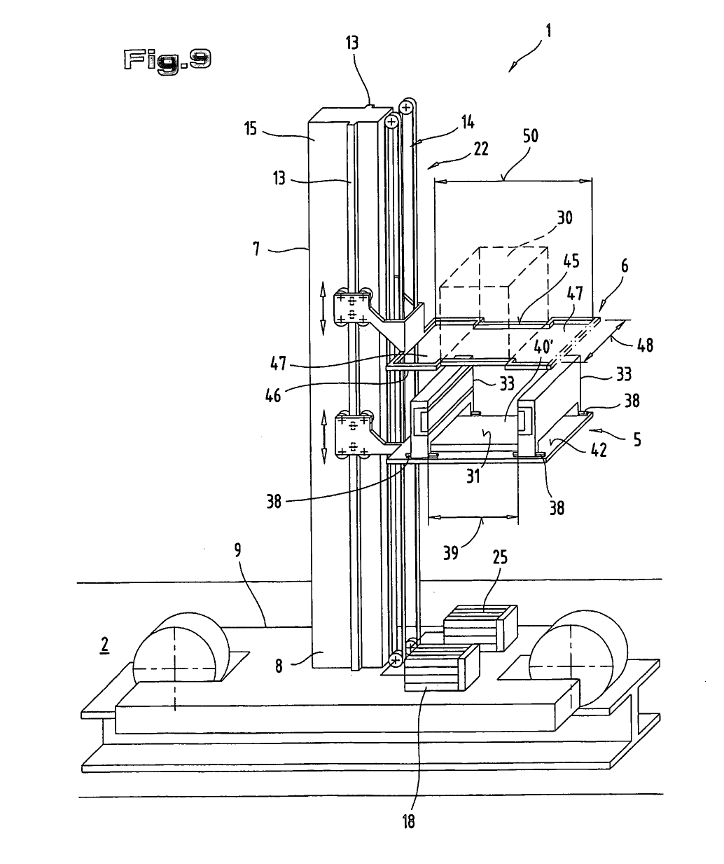

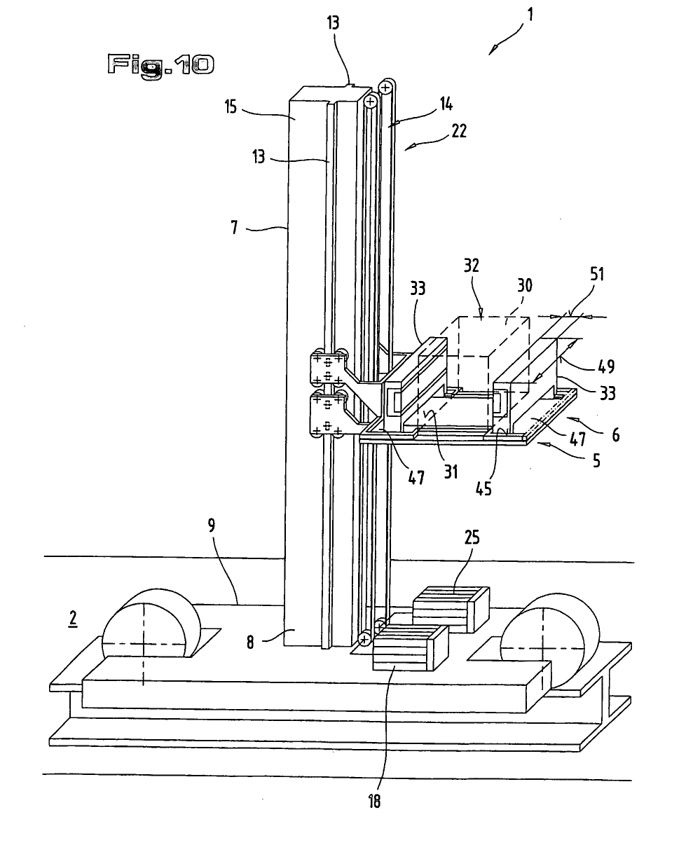

FIG. 9 is a schematic diagram showing a perspective view of the conveyor system proposed by the invention with a different embodiment of the holding table, where the holding table is raised into its conveying position;

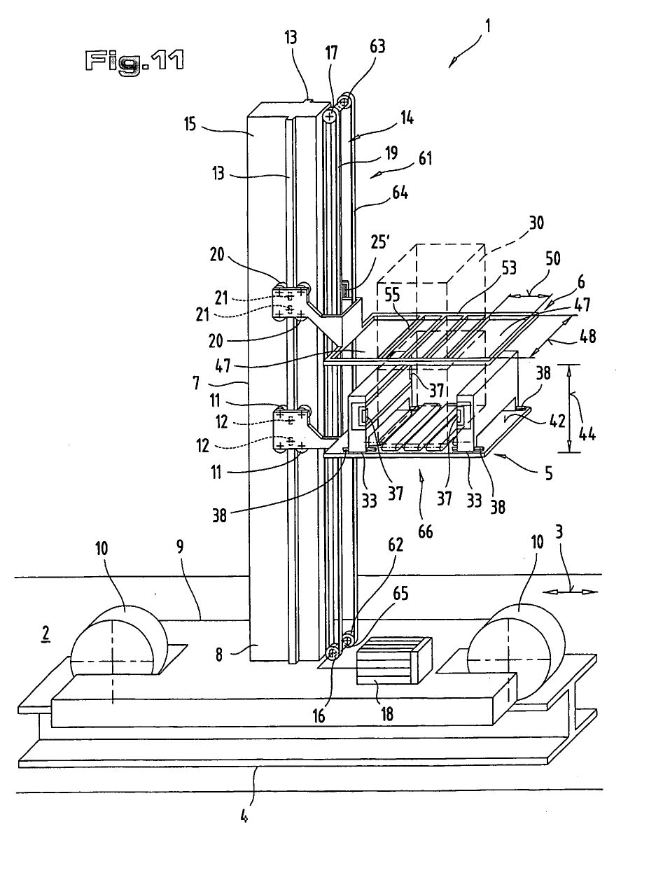

FIG. 10 is a schematic diagram showing a perspective view of the conveyor system illustrated in FIG. 9, with the holding table lowered into its transfer or handover position;

FIG. 11 is a schematic diagram showing a perspective view of the conveyor system proposed by the invention with a different embodiment of the drive for the holding table, with the holding table raised into its conveying position;

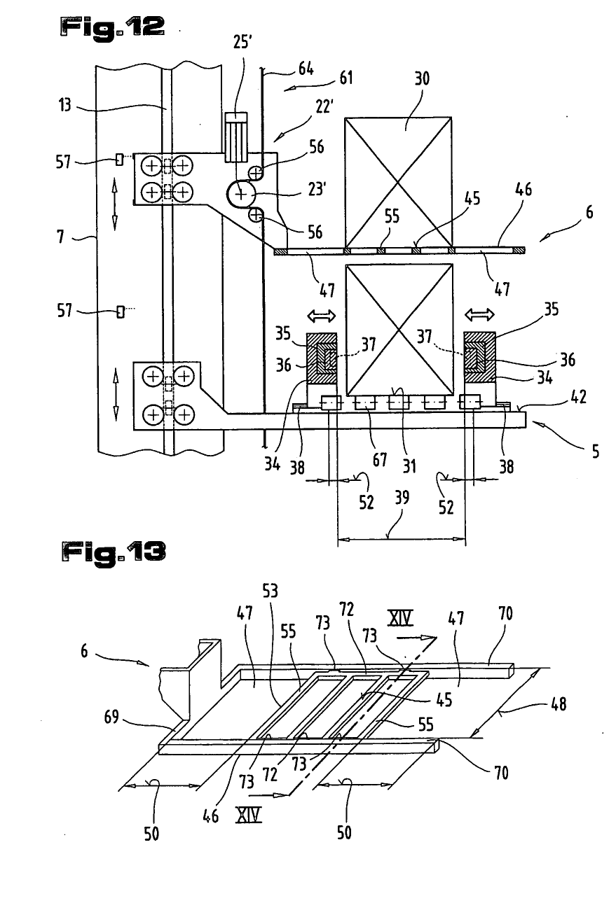

FIG. 12 is a schematic diagram in partial section showing a side view of a part-region of the conveyor system proposed by the invention illustrated in FIG. 11, incorporating the lifting platform and with the holding table raised into the conveying position;

FIG. 13 is a schematic diagram showing a perspective view of another embodiment of the holding table with the lifting frame and lifting grill constituting it;

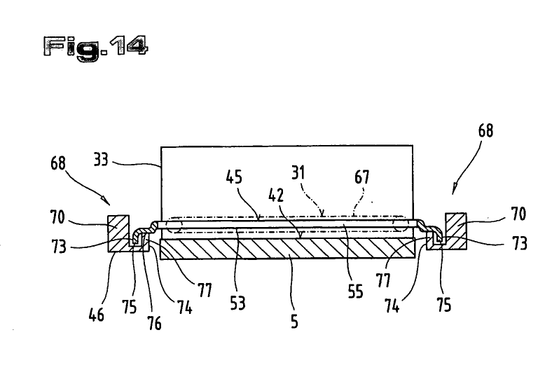

FIG. 14 is a section through the holding table with the lifting frame and lifting grill constituting it, viewed along line XIV-XIV indicated in FIG. 13.

Firstly, it should be pointed out that the same parts described in the different embodiments are denoted by the same reference numbers and the same component names and the disclosures made throughout the description can be transposed in terms of meaning to same parts bearing the same reference numbers or same component names. Individual features or combinations of features from the different embodiments illustrated and described may be construed as independent inventive solutions or solutions proposed by the invention in their own right.

FIGS. 1 to 4 illustrate a conveyor system proposed by the invention, comprising a conveyor vehicle, in particular shelf-stacking device 1, for a storage system. The shelf-stacking device 1 is disposed between two oppositely lying storage shelves (not illustrated) in a shelf aisle 2 and can be moved in the aisle direction—indicated by double arrow 3—along a bottom drive track 4 secured to the floor under the control of a computer. The shelf-stacking device 1 has a lifting platform 5 which can be moved in the vertical direction, a holding table 6 which can be vertically raised and lowered relative to it and a vertical mast 7, which can be driven by means of a bogie assembly 9 at the mast base 8 and supported on the bottom drive track 4 by means of two wheels 10. The wheels 10 are mounted on the two sides of the mast 7 so as to be rotatable on the bogie assembly 9 one behind the other in the aisle direction—indicated by double arrow 3—and at least one of the wheels 10 can be driven and is coupled with a drive motor, although this is not illustrated.

The lifting platform 5 is guided on the mast 7 by means of guide elements 11, 12, in particular lateral guide rollers, on guide tracks 13, in particular linear guides, and can be moved vertically along the guide tracks 13 by means of a first lifting drive 14. The lifting drive 14 has a driving gear 16 mounted on the mast 7 in the region of the mast base 8, a guide pulley 17 mounted on the mast 7 in the region of a mast head 15 and a traction means 19 guided by means of the drive and guide pulley 16, 17, with its free ends attached to the lifting platform 5, which can be driven by means of a drive motor 18. The drive motor 18 is mounted on the bogie assembly 9 and is coupled with the driveable driving gear 16 with an interconnected gear system if necessary.

In the embodiment illustrated, the holding table 6 is guided by means of guide elements 20, 21, in particular lateral guide rollers, on the guide tracks 13 on the mast 7 providing a mount for the lifting platform 5 and can be displaced vertically along the guide tracks 13 by means of a second lifting drive 22. Like the first lifting drive 14, the second lifting drive 22 also has a driving gear 23 mounted on the mast 7 in the region of the mast base 8, a guide pulley 24 mounted on the mast 7 in the region of the mast head 15 and a second traction means guided by the drive and guide pulley 23, 24, with its free ends attached to the holding table 6, which can be driven by means of a second drive motor 25. The driving gear 23 forms a driven means and the second traction means 26 constitutes a driver, the two engaging with one another in a positive or frictional connection. The second drive motor 25 is mounted on the bogie assembly 9 and is coupled with the driveable driving gear 23, optionally with an inter-connected gear system.

The finite traction means 19, 26 of the first and second lifting drive 14, 22 are flexible, for example in the form of a chain, cogged belt, cable or similar. The drive and guide pulleys 16, 17, 23, 24 are provided in the form of toothed gears, toothed racks, pulley sheaves and similar.

As may be seen from the drawing, the lifting platform 5 has a depositing area on which at least one storage aid 30, such as a container, box and similar, can be deposited exclusively in one plane for holding stored items, and to ensure greater clarity, the storage aids 30 in FIGS. 1 and 2 are merely indicated by broken lines. On the side facing the holding table 6, the lifting platform 5 affords a flat support surface 31 on which the at least one storage aid 30 sits. If more than one storage aid 30 has to be deposited in the depositing area, the lifting platform 5 is made longer in terms of its length parallel with the shelf aisle. For example, two storage aids 30 are deposited one behind the other in the aisle direction—indicated by double arrow 3—so that the lifting platform 5 does not have to be made wider by the external dimension of the additionally accommodated storage aid 30. This enables the width of the shelf aisle 2 and the distance between the storage shelves disposed in mirror image on either side of the shelf-stacking device 1 to be kept to a minimum.

In order to stow and retrieve storage aids 30 in and from a shelf compartment of the shelving system, a load bearing mechanism 32 is provided, which is disposed on the lifting platform 5. This load bearing mechanism 32 has two parallel telescopic pushing arms 33 lying adjacent to one another in a horizontal plane and disposed in mirror image by reference to a transverse plane extending perpendicular to the longitudinal extension of the lifting platform 5, which can be extracted synchronously by means of at least a first displacement drive (not illustrated) on both sides by reference to the lifting platform 5 in the direction of the shelf compartments of the storage shelves disposed on either side of the shelf-stacking device 1 and are mounted on the lifting platform 5.

Disposed so that they can be extracted synchronously and in the same direction towards the shelf compartments, the telescopic pushing arms 33 are designed to enable two depth positions in the shelf compartment lying one behind the other in the extraction direction to be approached. Accordingly, a storage aid 30 may be deposited in the shelf compartment at a front depth position close to the aisle and/or in a rear depth position in the shelf compartment farther away from the aisle on the one hand, and transferred from the front depth position in the shelf compartment close to the aisle and/or from the rear depth position in the shelf compartment farther away from the aisle onto the lifting platform 5, on the other hand.

Each telescopic pushing arm 33 has a support frame 34 and retractable and extractable middle and/or top carriages 35, 36, which middle and/or top carriages 35, 36 are displaceable relative to the support frame 34 and optionally relative to one another. The middle and top carriages 35, 36 are guided in linear guides extending in the extraction direction of the telescopic pushing arms 33, preferably slide guides (not illustrated) on the support frame 34 and are guided with respect to one another.

The top carriages 36 adjacent to the storage aid 30 deposited in the depositing area between the telescopic pushing arms 33 are respectively provided with driving elements 37 at their terminal ends which can be displaced from a non-operating position disposed transversely to the longitudinal direction of the telescopic pushing arms 33 into an operating position projecting out from the external boundary of the top carriage 36, in particular pivoting flaps. When the driving elements 37 are pivoted out into their operating position lying opposite one another in pairs by reference to the transverse plane, the storage aid 30 is positively engaged on one of the front or rear side walls of the telescopic pushing arms 33 in the retraction or extraction direction and pushed from the lifting platform 5 into the shelf compartment or from the shelf compartment onto the lifting platform 5, so that the storage aid 30 slides along the support surface 31 as it is transferred from the lifting platform 5 and picked up again from the lifting platform 5.

For more details of the design of the telescopic pushing arms 33, driving elements 37 and the operating mode of the load bearing mechanism 32 for stowing ad retrieving storage aids 30 in and from a shelf compartment of the shelving system, more detailed disclosures may be found in patent specification US 2003/0185656 A1 (Hansl) which is also included in these disclosures by way of reference.

It has proved to be of particular advantage if the telescopic pushing arms 33 are mounted so that they can also be displaced on the lifting platform 5 transversely to their longitudinal extension. The telescopic pushing arms 33, in particular the support frame 34, are guided on linear guides 38, in particular roller or slide guides. In this embodiment, the linear guides 38 are disposed in pairs, transversely to the longitudinal extension of the telescopic pushing arms 33 at a distance from one another on the lifting platform 5 in the region of its longitudinal edges, and extend parallel with the longitudinal extension of the lifting platform 5.

In the simplest situation, the second displacement drive (not illustrated) for displacing the telescopic pushing arms 33 synchronously and in the same direction is provided in the form of a traction drive, comprising a driving gear coupled with a drive motor, a guide pulley and an endless traction means guided around it, and the first telescopic pushing arm 33 is fixedly connected to the load-bearing strand and the second telescopic pushing arm 33 is fixedly connected to the empty strand of the traction means so that when the driving gear is driving in the anti-clockwise direction, the telescopic pushing arms 33 are moved towards one another, whereas when the driving gear is driving in the clockwise direction, the telescopic pushing arms 33 are moved away from one another. The rotation axes of the drive and guide pulleys extend perpendicular to the support surface 31 for the storage aid 30 and the entire traction drive is disposed on the lifting platform 5 on the side facing away from the support surface.

For more details of the design of the displacement drive and the operating mode of the load bearing mechanism 32 for stowing and retrieving storage aids 30 in and from a shelf compartment of the shelving system, reference may be made to the more detailed disclosures of patent specification US 2003/0185656 A1 (Hansl), which are included in these disclosures by way of reference.

With his embodiment, the telescopic pushing arms 33 can be moved so close together that a minimum clearance width 39 between the telescopic pushing arms 33 is at least 200 mm and when the telescopic pushing arms 33 are moved to the maximum distance apart, the clearance width 39 between the telescopic pushing arms 33 is at least 600 mm, which means that storage aids 31 with differing external dimensions (length/width) can now be conveyed as well as stowed and retrieved without any difficulty.

As may be seen from the drawings, a support frame 40 is provided on the lifting platform 5, which forms the support surface 31 directed towards the storage aid 30 and comprises several parallel support surfaces 41 disposed adjacent to one another at a distance apart and extending in the direction of the longitudinal extension of the telescopic pushing arms 33. These support surfaces 41 form the depositing area on the lifting platform 5 and project vertically along a mounting surface 42 extending parallel with the support surface 31 for the storage aid 30. The linear guides 38 for the telescopic pushing arms 33 described above are expediently mounted on this mounting surface 42. To enable the clearance width 39 between the telescopic pushing arms 33 to be adjusted unhindered, the two telescopic pushing arms 33, in particular the support frames 34, are respectively provided with a free space 43 in their longitudinal extension.

As described above, in a preferred embodiment, the lifting platform 5 is designed so that it is just narrow and long enough for only a single storage aid 30 to be deposited on the depositing area of the lifting platform 5. However, the holding table 6 is provided in order to enable two storage aids 30 to be driven with the shelf-stacking device 1 and in a first embodiment is guided on the mast 7 along the guide tracks 13.

The holding table 6 and the lifting platform 5 are disposed vertically one above the other and have an essentially identical external contour, and the longitudinal dimension of the holding table 6 perpendicular to the longitudinal extension of the telescopic pushing arms 33 and the width dimension parallel with the longitudinal extension of the telescopic pushing arms 33 are slightly bigger than those of the lifting platform 5 or correspond to those of the lifting platform 5. The holding table 6 can be displaced by means of the second lifting drive 22 out of a transfer or handover position illustrated in FIG. 2 flush with the horizontal support surface 31 of the lifting platform 5 or lower than the support surface 31 of the lifting platform 5, into a conveying position illustrated in FIG. 1 lying above the lifting platform 5, in particular the support surface 31, by the distance of a travel path 44. The vertical travel path 44 is only slightly longer than the maximum height of the storage aid 30, so that at least one respective storage aid can be deposited simultaneously on the lifting platform 5 and on the holding table 6. The holding table 6 with the first storage aid 30 is raised just far enough to enable a second storage aid 30 to be conveyed on the lifting platform 5 and stowed and retrieved unhindered.

When the holding table 6 is in the transfer or handover position, a storage aid 30 can be pushed by means of the load bearing mechanism 32 from a storage or retrieval point in the upstream zone at the terminal end of the shelf aisle 2 or from the shelf compartment onto the holding table 6 on the one hand, and a storage aid 30 can be pushed off the holding table 6 at a storage or retrieval point in the upstream zone at the terminal end of the shelf aisle 2 or from a shelf compartment on the other hand. The transfer of the two storage aids 30 into the shelf compartments or at the storage or retrieval point and the process of retrieval from the shelf compartments or from the storage or retrieval point are preferably handled by means of the load bearing mechanism 32 on the lifting platform 5.

The conveying position of the holding table 6 lies in a plane offset from the lifting platform 5 by the distance of the travel path 44 in the direction towards the mast head 15 in which at least one storage aid 30 can also be conveyed by the holding table 6 exclusively in one plane.

To enable the holding table 6 to be moved far enough for a support surface 45 afforded by it to be positioned flush with the support surface 31 of the lifting platform 5 or lowered to a position underneath the support surface 31 of the lifting platform 5 in its transfer or handover position, a plateau-type lifting frame 46 is provided which, in this embodiment, has two orifices 47 which co-operate with the telescopic pushing arms. These parallel orifices 47 are approximately rectangular and are spaced apart from one another by at last the dimension of the minimum clearance width 39 between the telescopic pushing arms 33, disposed at oppositely lying peripheral regions of the lifting frame 46 transversely to the longitudinal extension of the telescopic pushing arms 33. Each orifice 47 has a first main dimension 48 parallel with the longitudinal extension of the telescopic pushing arms 33, which is slightly longer than the maximum length 49 of each of the telescopic pushing arms 33 retracted towards the lifting platform 5. A second main dimension 50 of each orifice 47, as measured perpendicular to the longitudinal extension of the telescopic pushing arms 33, is longer than the maximum width 51 of each of the telescopic pushing arms 33 retracted towards the lifting platform 5 plus a maximum displacement path 52 of each telescopic pushing arm 33. When the holding table 6 is in the transfer or handover position, the telescopic pushing arms 33 extend vertically through the orifices 47. When the holding table 6 is in the conveying position, the telescopic pushing arms 33 are outside the orifices 47. In addition, in the transfer or handover position, the support surface 45 of the holding table 6 extends at least slightly below the retractable and extractable middle and/or top carriages 35, 36 so that the middle and top carriages 35, 36 can be extracted and retracted unhindered when stowing and retrieving the storage aids 30.

Disposed between the orifices 47 is a lifting grill 53 incorporating the holding table 6, which, in a first embodiment, is made integrally with the lifting frame 46 and bounds the orifices 47. The lifting grill 53 is of an approximately rectangular shape and has a peripherally extending frame and adjacent parallel support bars 55 disposed between the frame parts one after the other in the longitudinal extension of the telescopic pushing arms 33 at a distance apart, extending in one plane. Together with the lifting grill 54, the holding table 6 forms a depositing area, on which a storage aid 30 can be deposited lying exclusively in one plane. If more than one storage aid 30 has to be deposited on the depositing area, the holding table 6 is made longer in terms of its length extending parallel with the shelf aisle 2. For example, two storage aids 30 are deposited one after the other in the aisle direction—indicated by double arrow 3. The support surface 45 of the holding table 6, on which the at least one storage aid 30 lies, is formed by the lifting grill 53, in paticular the support bars 55 and the two frame parts. As may be seen from FIGS. 3 and 4, the width of the support bars 55 of the lifting grill 53 is slightly shorter tam the distance between the support surfaces 41 of the support frame 40.

The lifting platform 5 and the holding table 6 may be displaced relative to one another on the mast 7 and within a set distance with respect to one another in synchronization. This is done by activating the drive motors 18 of the first lifting drive 14 and the drive motor 25 of the second lifting drive 22 independently of one another, on the one hand, and by driving them electrically in synchronization, on the other hand. As soon as the holding table 6 has reached its conveying position, the travel path 44 remains constant and the holding table 6 and lifting platform 5 can then be moved jointly into a desired position pre-defined by the computer system. This will be the case when the shelf-stacking device 1 is moved along shelf aisle 2 and the desired position of the lifting platform 5 in front of a shelf compartment or a storage or retrieval point in the upstream zone is being approached. If the storage aid 30 deposited on the holding table 6 has to be transferred, the holding table 6 is lowered onto the lifting platform 5. Naturally, the lifting platform 5 and holding table 6 can also be synchronously displaced when the holding table 6 is disposed in the transfer or handover position.

FIGS. 5 and 6 are schematic diagrams illustrating a part-region of the shelf-stacking device 1 proposed by the invention with a different embodiment of the second lifting drive 22′ for the holding table 6, where FIG. 5 shows the holding table 6 positioned and retained in the conveying position and is accommodating a storage aid 30, whilst FIG. 6 illustrates the holding table 6 in its transfer or handover position lowered towards the lifting platform 5 with a storage aid 30 deposited on the lifting platform 5. The holding table 6 can be displaced relative to the lifting platform 5 and is mounted on the linear guides extending parallel with the mast 7. The linear guides are formed by the guide tracks 13 for the lifting platform 5.

Rotatably mounted on the holding table 6 is the driving gear 23′ serving as a drive, and guide pulleys 56 at its two sides, which form the second lifting drive 22′ in conjunction with the drive motor 25′.

In order to effect a vertical displacement of the holding table 6 relative to the lifting platform 5, the traction means 19 serving as a driver, in particular a cogged belt or a chain, of the first lifting drive 14 for the lifting platform 5 is guided by the driving gear 23′ and guide pulleys 56 so that the traction means 19 loops round the drive roller 23′ by at least 180°. As already described above in connection with FIGS. 1 and 2, the traction means 19 of the first lifting drive 14 is guided around the driving gear 16 disposed in the region of the mast base 8 and the guide pulley 17 disposed in the region of the mast head 15, and its free ends are secured to the lifting platform 5. An exact positioning of the holding table 6 in the vertical direction is achieved by the positive engagement of the traction means 19 and the driving gear 23′ of the second lifting drive 22′ serving as a driving means. The drive motors 18, 25′ of the lifting drives 14, 22′ can be actuated separately and also synchronously, so that the lifting platform 5 and the holding table 6 can be controlled independently of and separately from one another or can also be run synchronously.

As also illustrated in the drawings, end-position limit switches 57 are provided at the height of the transfer or handover position and the conveying position of the holding table 6, in particular sensors, such as light barriers, which are switched whenever the corresponding position is reached and the drive motor 25′ of the second lifting drive 22′ is halted. The end-position limit switches 57 are preferably mounted on the lifting platform 5, although this is not illustrated in detail.

As soon as the holding table 6 has reached its conveying position, a holding brake is preferably actuated by a control system, so that the second driving gear 23′ can no longer rotate relative to the holding table 6 and the holding table 6 is held stationary in its conveying position. The traction means 19 is then displaced and the holding table 6 and the lifting platform 5 are displaced together, and the travel path 44 is maintained constant during the displacement. When air is applied to the holding brake, the driving gear 23′ positively engaging in the traction means 19 is then displaced in a rotating motion relative to the holding table 6 by the driving action of the drive motor 25′ so that the driving gear 23′ rolls off the traction means 19 and the holding table 6 can be moved vertically in the direction towards the lifting platform 5 into the transfer or handover position. The system may also be set up so that the holding table 6 can also be locked in its transfer or handover position by means of the holding brake so that the storage aid 30 can be stowed in or retrieved from a shelf compartment unhindered. For reasons of weight, the holding brake is preferably provided in the form of an electromagnetic magnetically operated brake.

The same preferably also applies to the lifting platform 5. It may also be locked in a desired position in the vertical direction by means of a holding brake, in particular an electromagnetic magnetically operated brake. The holding brakes for the lifting platform 5 and the holding table 6 are respectively integrated in the drive motor 18, 25.

FIGS. 7 and 8, which will be described together, illustrate a part-region of the shelf-stacking device 1 proposed by the invention illustrated in FIGS. 6 and 7 with the second lifting drive 22′ and a different embodiment of the guide for the holding table 6. In FIG. 7, the holding table 6 is positioned and retained in the conveying position lifted away from the lifting platform 5 and in FIG. 8 in the transfer or handover position moved towards the lifting platform 5.

In this embodiment, the linear guide 58 extending parallel with the mast 7 is disposed between the lifting platform 5 and the holding table 6 separately from the mast 7 and has a pair of complementary guided and telescopically extractable guide elements 59, 60. The linear guide 58 may be provided in the form of sliding or roller guides, such as prismatic or roller guides and similar. Accordingly, the holding table 6 is guided on the lifting platform 5 by the linear guide 58 on the side facing the mast 7 only. The guide elements 59, 60 are vertically displaceable relative to the lifting platform 5 and relative to one another. The two guide elements 60 are mounted on the holding table 6, whilst guide elements 59 are slidingly mounted on the lifting platform 5.

FIGS. 9 and 10, which will be described together, illustrate the shelf-stacking device 1 described above with a different embodiment of the holding table 6 and lifting platform 5, where FIG. 9 shows the holding table 6 positioned and retained in the conveying position with a storage aid 30 disposed on it, whilst FIG. 10 shows the holding table 6 in its transfer or handover position moved towards the lifting platform 5 with a storage aid 30 deposited on it.

The holding table 6 in this instance has only one orifice 47 in its lifting frame 46, which has a first main dimension 48 parallel with the longitudinal extension of the telescopic pushing arms 33 which is slightly longer than the maximum length 49 of each of the retracted telescopic pushing arms 33 on the lifting platform 5. A second main dimension 50 of the orifice 47 perpendicular to the longitudinal extension of the telescopic pushing arms 33 is longer than the sum of the widths 51 of the two telescopic pushing arms 33 retracted towards the lifting platform 5 plus the maximum displacement paths 52 (as was the case with FIG. 3, for example) of the two retracted telescopic pushing arms 33.

The remaining peripheral web of the lifting frame 46 is then U-shaped or frame-shaped, as indicated by dotted-dashed lines, and forms the depositing area for the at least one storage aid 30, in which case the storage aid 30 is supported by its base on the part-webs lying one behind the other in the extraction direction of the telescopic pushing arms 33. The holding table 6 therefore has an external contour matching the external contour of the lifting platform 5, thus matching the length and width dimensions. The holding table 6 is mounted on the mast 7 so that it can be displaced by means of the second lifting drive 22 from the transfer or handover position in which it sits flush with the horizontal support surface 31 of the lifting platform 5 or is lower than the support surface 31 of the lifting platform 5, as illustrated in FIG. 10, by the distance of the travel path 44 (not indicated) above and beyond the support surface 31 into the conveying position, as illustrated in FIG. 9.

The support frame 40′ for the storage aid 30 is disposed on the lifting platform 5 and forms a flat, uninterrupted support surface 31. The support surface 31 is disposed offset from the horizontal mounting surface 42 in the direction towards the holding table 6, so that the support surface 45 of the holding table 6 can now be moved into a transfer or handover position flush with the support surface 31 or into a position lower than it.

When the holding table 6 is in the lowered transfer or handover position, the two telescopic pushing arms 33 extend through the orifices 47 and it is still possible to adjust the clearance width 39 between the telescopic pushing arms 33 transversely to their longitudinal extension without colliding with the holding table 6.

FIGS. 11 and 12, which will be described together, illustrate different views of the shelf-stacking device 1 proposed by the invention illustrated in the preceding drawings and described in detail but with a different embodiment of the drive for the holding table 6. In the region of the mast base 8, the first lifting drive 14 has a first driving gear 16 mounted on the mast 7, the first guide pulley 17 mounted on the mast 7 in the region of the mast head 15 and the traction means 19 guided by means of the first drive and guide pulley 16, 17 with its free ends secured to the lifting platform 5 and driven by means of the drive motor 18. Offset to the side of the first lifting drive 14, an auxiliary drive 61 is mounted on the mast 7. In the region of the mast base 8, it has a second driving gear 62 mounted on the mast 7, a second guide pulley 63 mounted on the mast 7 in the region of the mast head 15 and a traction means 64 of an endless circulating design guided by the second driving gear 62 and second guide pulley 63. The second driving gear 62 is rigidly connected via a coupling shaft 65 so that it rotates with the first driving gear 16 and is coupled with the drive motor 18 of the lifting platform 5, thereby enabling the traction means 19 to be driven by the first lifting drive 14 and enables the traction means 64 running with it in the same direction to be driven by the auxiliary drive 61 in synchronization. The traction means 64 serving as a driver is provided in the form of cogged belt, a chain or similar and is of smaller dimensions than the traction means 19 of the first lifting drive 14, for example.

As schematically illustrated in FIG. 12, the holding table 6 is equipped with the second lifting drive 22′ which, as already described above, comprises the driveable third driving gear 23′ and the guide pulleys 56 at its two sides, each of which is mounted on the holding table 6 so that it can rotate and in conjunction with the drive motor 25′ constitute the second lifting drive 22′. The traction means 64 of the auxiliary drive 61 is guided by means of the third driving gear 23′ and the third guide pulleys 56, and the traction means 64 loops round the third driving gear 23′ by at least 180°. The third driving gear 23′ serving as a driving means is coupled with the drive motor 25′ of the second lifting drive 22′. In this embodiment, the holding table 6 can now be vertically displaced by the driven third driving gear 23′ along the strand of the traction means 64 of the auxiliary drive 61 guided between the second driving gear 62 and the second guide pulley 63. The maximum displacement path of the holding table 6 in the direction towards the lifting platform 5 and in the direction of the mast head 15 is restricted by the end-position limit switches 57, and the displacement stroke 44 of the holding table 6, which can be moved out of the transfer or handover position on the lifting platform 5, not illustrated, into the conveying position illustrated in FIGS. 11 and 12, is essentially only slightly longer than the maximum height of the storage aid 30 to be conveyed.

The drive motor 18 for the lifting platform 5 and the drive motor 25′ for the holding table 6 can again be actuated synchronously or independently of one another as described above, so that the lifting platform 5 and the holding table 6 can be moved at a fixed distance from one another synchronously along the mast 7 on the one hand, and the holding table 6 and the lifting platform 5 can be moved relative to one another along the mast 7 on the other hand.

As also illustrated in these drawings, a longitudinal conveyor system 66 which conveys in the direction of the extractable and retractable middle and/or top carriages 35, 36 may be disposed on the lifting platform 5 between the telescopic pushing arms 33, which can be moved towards one another and away from one another. It has several parallel endless conveyors 67 disposed adjacent to one another and at a distance apart, in particular belt conveyors, chain conveyors or similar, the top strands of which adjacent to the holding table 6 form the depositing area for the storage aid 30 and the flat support surface. The distance between the endless conveyors 67 is slightly bigger than the width of the support bars 55 of the lifting grill 53. The direction of rotation of the driven endless conveyors 67 is reversible and in the same direction as the retraction or extraction movement of the telescopic pushing arms 33.

FIGS. 13 and 14, finally, illustrate a different embodiment of the lifting grill 53 and the support frame 46 of the holding table 6, FIG. 13 showing only a part-region of the holding table 6 and FIG. 14 showing the holding table 6 with its lifting grill 53 and support frame 46 lowered into the transfer or handover position towards the lifting platform 5. This embodiment may primarily be used to advantage with the embodiments described above in connection with FIGS. 11 and 12. By contrast with the embodiments described above, the lifting grill 53 in this instance is rigidly connected to the lifting frame 46, and the lifting grill 53 in this embodiment is provided separately from the lifting frame 46 and mounted so that it can be moved vertically when necessary via coupling mechanisms 68 on the lifting frame 46.

The lifting frame 46 in this embodiment has two parallel, freely projecting fork-type support arms 70 on a base 69. The depositing area for the storage aid 30 (not illustrated) is provided by the lifting grill 53, in particular the support bars 55.

The lifting grill 53 is disposed between the support arms 70 and its outermost support bars 55 bound the orifices 47 separated from one another by the lifting grill 53 on their mutually facing sides. The lifting grill 53 is of an approximately rectangular shape and has a peripheral frame and parallel frame parts 72 with parallel support bars 55 extending adjacent to one another at distance apart and disposed one after the other in extraction direction between the telescopic pushing arms 33.

Tie coupling mechanisms 68 are respectively provided in the form of two mutually engaging coupling parts 73, 74 which can be released from one another and are preferably disposed vertically one above the other, of which the first coupling parts 73 are disposed on the lifting grill 53 and the second coupling parts 74 are disposed on the support arms 70 of the lifting frame 46. The first coupling parts 73 of the lifting grill 53 are disposed opposite one another in pairs and are disposed on the frame parts 72 at a distance apart transversely to the longitudinal extension of the telescopic pushing arms 33, forming forwardly projecting L-shaped hooking arms 75 on the frame parts 72. The leg of the hooking arms 75 extending parallel with the support surface 45 of the lifting grill 53 forms a horizontal support surface 76.

The second coupling parts 74 of the lifting frame 46 are disposed lying opposite one another in pairs and at a distance apart transversely to the longitudinal extension of the telescopic pushing arms 33 on the support arms 70, disposed one after the other in the extraction direction of the telescopic pushing arms 33. The spacing of the first coupling parts 73 of the lifting grill 53 is the same as the spacing of the second coupling parts 74 of the lifting frame 46. The second coupling parts 74 disposed lying opposite one another in pairs are formed by hooking lugs 77 directed towards one another, which are formed on the part-webs 77 and are approximately U-shaped.

The lifting grill 53 is mounted on the lifting frame 46, and the hooking arms 75 formed on the lifting grill 53 project with their legs pointing towards the support surface 76 extending vertically in the direction of the lifting platform 5 into the approximately U-shaped hooking lugs 77. As a result, the lifting grill 53 lies loosely on the lifting frame 46. By means of the mutually engaging coupling parts 73, 74, the lifting grill 43 is also simultaneously positioned with respect to the lifting frame 46.

As may be seen from FIG. 13, a width of the lifting grill 43 is only slightly shorter than the clearance width between the two support arms 70 of the lifting frame 46 and its length is dimensioned so that the support bar 55 adjacent to the mast 7 bounds the first orifice 47 between the lifting frame 46 and this support bar 55 in the second main dimension 50. The support bar 55 of the lifting grill 53 facing away from the mast 7 bounds one side of the second orifice 47, which is open at one side.

In another embodiment, although this is not illustrated, the lifting grill 43 is disposed between the two support arms 70 so that the support bar 55 facing away from the mast 7 forms the transverse connection between the free ends of the support arms 70 and bounds the second main dimension 50 of the second orifice 47 with the outermost support bar 55 and the other parallel support bar 55 adjacent to and parallel with it. The first main dimension 48 is bounded by part-sections of the lifting grill frame. Accordingly, the right-hand orifice 47 is formed by the lifting grill and is surrounded by it on all sides, whilst the left-hand orifice 47 is formed between the lifting frame 46 and the lifting grill 53 and is bounded by the lifting grill 53 on one side only, in particular the support bar 55 facing the mast 7. The main dimensions 48, 50 are fixed by reference to the length 49 and width 51 of the telescopic pushing arms 33, as described above, and the same applies to this embodiment.

As may be seen from FIG. 13, the lifting grill 53 lies above the coupling parts 73 on the coupling parts 74 of the lifting frame 46. This has an advantage because different length variations may occur in the traction means 19, 64 of the first lifting and auxiliary drive 14, 61 leading to inaccurate positioning of the holding table 6 relative to the lifting platform 5 in the transfer or handover position, and a possible collision between the holding table 6 and the lifting platform 5 which would otherwise cause mechanical damage can be avoided. Accordingly, if an unforeseen change of length occurs in the traction means 64 of the auxiliary drive 61, the lifting grill 53 is also moved relative to the stationary lifting platform 5 until it lies on the lifting platform 5, and if the change of length is even greater, the lifting frame 46 and the lifting grill 53 are displaced relative to one another or moved apart from one another, and the lifting grill 53 is then supported solely on the lifting platform 5. When the holding table 6 is moved into the conveying position, the lifting frame 46 is firstly moved towards the lifting grill 53 deposited on the lifting platform 5, then the coupling parts 73, 74 are moved into engagement again if necessary, the lifting grill 53 is oriented relative to the lifting frame 46 and is raised together with the lifting frame 46.

For the sake of good order, it should finally be pointed out that, in order to provide a clearer understanding of the structure of the conveyor system 1, it and its constituent parts are illustrated to a certain extent out of scale and/or on an enlarged scale and/or on a reduced scale.

Above all, the individual embodiments of the subject matter illustrated in FIGS. 1, 2, 3, 4; 5, 6; 7, 8; 9, 10; 11, 12; 13, 14 may be construed as independent solutions proposed by the invention.

### LIST OF REFERENCE NUMBERS

1 Shelf-stacking device
2 Shelf aisle
3 Aisle direction
4 Drive track
5 Lifting platform
6 Holding table
7 Mast
8 Mast base
9 Bogie assembly
10 Driving gear
11 Guide element
12 Guide element
13 Guide track
14 Lifting drive
15 Mast head
16 Driving gear
17 Guide pulley
18 Drive motor
19 Traction means
20 Guide element
21 Guide element
22 Lifting drive
22′ Lifting drive
23 Driving gear
23′ Driving gear
24 Guide pulley
25 Drive motor
25′ Drive motor
26 Traction means
30 Storage aid
31 Support surface
32 Load bearing mechanism
33 Telescopic pushing arm
34 Support frame
35 Middle carriage
36 Top carriage
37 Driving element
38 Linear guide
39 Clearance width
40 Support frame
40′ Support frame
41 Support surface
42 Mounting surface
43 Free space
44 Displacement stroke
45 Support surface
46 Lifting frame
47 Orifice
48 Main dimension
49 Length

50 Main dimension
51 Width
52 Displacement path
53 Lifting grill
55 Support bar
56 Guide pulley
57 End-position limit switch
58 Linear guide
59 Guide element
60 Guide element
61 Auxiliary drive
62 Driving gear
63 Guide pulley
64 Traction means
65 Coupling shaft
66 Longitudinal conveyor system
67 Endless conveyor
68 Coupling mechanism
69 Base
70 Support arm
72 Frame part
73 Coupling part
74 Coupling part
75 Hooking arm
76 Support surface
77 Hooking lug

1-36. (canceled)

37. Computer-controlled conveyor system, in particular a shelf-stacking device (1), comprising a vertical mast (7) which can be moved horizontally by means of a bogie assembly (9), a lifting platform (5) which can be guided vertically on the former and displaced vertically by means of a first lifting drive (14), and a holding table (6), which can be vertically raised and lowered relative to it by means of a second lifting drive (22, 22′) and has a depositing area on which at least one storage aid (30) can be deposited lying exclusively in one plane, and a load bearing mechanism (32) is disposed on the lifting platform (5) for stowing and retrieving storage aids (30), such as containers, boxes and similar, in and out of a shelf compartment of a shelving system and having a depositing area on which at least one storage aid (30) can be deposited lying exclusively in one plane, and the lifting platform (5) and holding table (6) are disposed one above the other, wherein the load bearing mechanism (32) comprises two parallel telescopic pushing arms (33) lying adjacent to one another which can be moved synchronously towards one another and apart from one another to a limited degree by the distance of a displacement path (52) by means of a displacement drive, and which can be extracted in the direction of the shelf compartment for stowing and retrieving the storage aid (30), and the holding table (6) has a lifting frame (46) with an external contour approximately matching the external contour of the lifting platform (5) in which at least one orifice (47) is formed, and this orifice (47) has a first main dimension (48) parallel with the longitudinal extension of the telescopic pushing arms (33) which is slightly longer than the maximum length (49) of each of the telescopic pushing arms (33) retracted towards the lifting platform (5) and a second main dimension (50) perpendicular to the longitudinal extension of the telescopic pushing arms (33) which is longer than the sum of the maximum widths (51) of the telescopic pushing arms (33) retracted towards the lifting platform (5) plus the maximum displacement path (52) of each telescopic pushing arm (33), and the holding table (6) can be moved by means of the second lifting drive (22, 22′) from the transfer or handover position flush with a horizontal support surface (31) of the lifting platform (5) or lowered to below the support surface (31) of the lifting platform (5) into the conveying position above and beyond the support surface (31), and is mounted on at least one linear guide extending parallel with the mast (7), and when the holding table (6) is in the transfer or handover position, the two telescopic pushing arms (33) extend respectively through the Orifice (47).

38. Computer-controlled conveyor system according to claim 37, wherein a remaining, approximately U-shaped or frame-shaped peripheral web of the lifting frame (46) forms the depositing area and the storage aid (30) is supported on freely projecting support arms (70) disposed one after the other in the extraction direction of the telescopic pushing arms (33).

39. Computer-controlled conveyor system according to claim 37, wherein the lifting frame (46) has two parallel, approximately rectangular orifices (47) disposed in oppositely lying peripheral regions transversely to the longitudinal extension of the telescopic pushing arms (33), and each orifice (47) has a first main dimension (48) parallel with the longitudinal extension of the telescopic pushing arms (33) which is slightly longer than the maximum length (49) of each telescopic pushing arm (33) retracted towards the lifting platform (5), and has a second main dimension (50) perpendicular to the longitudinal extension of the telescopic pushing arms (33) which is longer than the maximum width (51) of each telescopic pushing arm (33) retracted towards the lifting platform (5) plus a maximum displacement path (52) of each telescopic pushing arm (33), and when the holding table (6) is in the transfer or handover position, a telescopic pushing arm (33) extends respectively through the orifices (47).

40. Computer-controlled conveyor system according to claim 37, wherein the telescopic pushing arms (33), in particular the support frame (34), are mounted on the lifting platform (5) by means of at least two linear guides (38) extending perpendicular to their longitudinal extension and spaced at a distance apart in their extraction direction and are respectively coupled with the displacement drive.

41. Computer-controlled conveyor system, in particular a shelf-stacking device (1), comprising at least one bogie assembly (9) which is able to travel horizontally alongside a vertical mast (7), a lifting platform (5) which can be guided vertically on the latter and displaced vertically by means of a first lifting drive (14), and a holding table (6) which can be vertically raised and lowered relative to it by means of a second lifting drive (22, 22′) and has a depositing area on which at least one storage aid (30) can be deposited, and a load bearing mechanism (32) is disposed on the lifting platform (5) for stowing and retrieving storage aids (30), such as containers, boxes and similar, in and out of a shelf compartment of a shelving system, and having a depositing area on which at least one storage aid (30) can be deposited lying exclusively in one plane, and the lifting platform (5) and holding table (6) are disposed one above the other, wherein the second lifting drive (22, 22′) for the holding table (6) comprising a drive motor (25, 25′), a driving means and a driver engaging in it in a positive and/or frictional connection is disposed separately from the lifting platform (5), and the holding table (6) can be displaced by means of the second lifting drive (22, 22′) between the transfer or handover position flush with a horizontal support surface (31) of the lifting platform (5) or lowered below the support surface (31) of the lifting platform and a conveying position raised lying above by at least the height of a storage aid (30), and sensors are provided as a means of controlling the drive motor (25; 25′) of the second lifting drive (22; 22′) so that the drive motor (25; 25′) of the second lifting drive (22; 22′) is switched off when the transfer or handover position is reached.

42. Computer-controlled conveyor system according to claim 41, wherein the drive means is disposed on the holding table (6) and the driver on the mast (7).

43. Computer-controlled conveyor system according to claim 41, wherein the drive means is disposed on the mast (7) and the driver on the holding table (6).

44. Computer-controlled conveyor system according to claim 41, wherein the drive means is provided in the form of at least one driven driving gear (23, 23′), such as a friction gear, toothed gear or toothed disc.

45. Computer-controlled conveyor system according to claim 41, wherein the driver is provided in the form of at least one traction means (19; 26; 64), such as a belt, chain or cable and similar, of the first lifting, second lifting or auxiliary drive (14; 22; 61) or at least one toothed rack mounted on the holding table (6) or mast (7) between a mast base (8) and a mast head (15) or at least one stationary tensed traction means mounted on the mast (7) between a mast base (8) and a mast head (15), such as a cogged belt or chain.

46. Computer-controlled conveyor system according to claim 41, wherein the drive motor (25′) of the second lifting drive (22′) is disposed on the holding table (6).

47. Computer-controlled conveyor system according to claim 41, wherein the drive motor (25) of the second lifting drive (14) is disposed on a bogie assembly (9) of the conveyor system or on the mast (7).

48. Computer-controlled conveyor system according to claim 41, wherein the holding table (6) co-operates with a first sensor on a level with its transfer or handover position and with a second sensor on a level with the conveying position, and the sensors are provided in the form of end-position limit switches (57).

49. Computer-controlled conveyor system according to claim 37, wherein the second lifting drive (22) comprises a driving gear (23) disposed in the region of the mast base (8), a guide pulley (24) disposed in the region of the mast head (15) and a traction means (26) guided by the drive and guide pulley (23, 24), connected to the holding table (6), which can be driven by means of a second drive motor (25).

50. Computer-controlled conveyor system according to claim 37, wherein the drive motor (25, 25′) for the holding table (6) and the drive motor (18) for the lifting platform (5) can be actuated independently of one another.

51. Computer-controlled conveyor system according to claim 37, wherein the drive motor (25, 25′) for the holding table (6) and the drive motor (18) for the lifting platform (5) are synchronized, in particular electrically and/or mechanically coupled.

52. Computer-controlled conveyor system according to claim 37, wherein the holding table (6) can be locked in its conveying position and/or transfer or handover position by means of a holding brake, in particular an electromagnetic magnetically operated brake.

53. Computer-controlled conveyor system according to claim 37, wherein the lifting platform (5) can be locked in its set relative position on the mast (7) by means of a holding brake, in particular an electromagnetic magnetically operated brake.

54. Computer-controlled conveyor system according to claim 52, wherein the drive motor (25, 25′) for the holding table (6) and/or the drive motor (18) for the lifting platform (5) is provided with the holding brake.

55. Computer-controlled conveyor system according to claim 37, wherein the first lifting drive (14) comprises a first driving gear (16) disposed in the region of the mast base (8), a first guide pulley (17) disposed in the region of the mast head (15) and a first traction means (19) guided by means of the drive and guide pulley (16, 17), connected to the lifting platform (5), and which can be driven by means of a first drive motor (18), and a second driving gear (23′) is mounted on the holding table (6) so as to be rotatable and has second guide pulleys (56) at its two sides, and the traction means (19) is guided by means of the second driving gear (23′) and the second guide pulley (56).

56. Computer-controlled conveyor system according to claim 55, wherein the traction means (19) loops round the second driving gear (23′) by at least 180°.

57. Computer-controlled conveyor system according to claim 37, wherein the first lifting drive (14) comprises a first driving gear (16) disposed in the region of the mast base (8), a first guide pulley (17) disposed in the region of the mast head (15) and a first traction means (19) guided by means of the drive and guide pulley (16, 17), connected to the lifting platform (5), and which cam be driven by means of a drive motor (18), and an auxiliary drive (61) is provided on the mast (7), which comprises a second driving gear (62) disposed in the region of the mast base (8), a second guide pulley (63) disposed in the region of the mast head (15) and an endless, second traction means (64) which is guided by means of the drive and guide pulley (62, 63) and can be driven by means of the first drive motor (18), and a third driving gear (23′) is mounted on the holding table (6) so as to be rotatable and has third guide pulleys (56) at its two sides, and the second traction means (64) is guided by means of the third driving gear (23′) and the third guide pulleys (56).

58. Computer-controlled conveyor system according to claim 37, wherein the linear guide (58) extends parallel with the mast (7) between the holding table (6) and the lifting platform (5).

59. Computer-controlled conveyor system according to claim 37, wherein the linear guide is disposed on the mast (7) extending parallel with the mast (7) and both the holding table (6) and the lifting platform (5) are guided on the linear guide on the mast (7) by means of guide elements (11, 12, 20, 21).

60. Computer-controlled conveyor system according to claim 37, wherein the lifting frame (46) is of a plate-shaped design and essentially overlaps with the entire surface of the lifting platform (5).

61. Computer-controlled conveyor system according to claim 37, wherein the holding table (6) also has a lifting grill (53) in addition to the lifting frame (46).

62. Computer-controlled conveyor system according to claim 61, wherein the holding table (6) is of a single-piece design and its lifting frame (46) and lifting grill (53) are rigidly connected to one another.

63. Computer-controlled conveyor system according to claim 61, wherein the holding table (6) is of a multi-part design and its lifting frame (46) and lifting grill (53) are connected to one another by means of coupling mechanisms (68) disposed between them, each with two mutually engaging but releasable coupling parts (73, 74).

64. Computer-controlled conveyor system according to claim 61, wherein the lifting grill (53) is of an approximately rectangular shape and comprises a peripheral frame and parallel support bars (55) disposed adjacent to one another in one plane at a distance apart between two frame parts in the extraction direction of the telescopic pushing arms (33).

65. Computer-controlled conveyor system according to claim 64, wherein the lifting frame (46) is formed by a peripherally extending frame and the lifting grill (53) is disposed inside this frame, and the orifices (47) are bounded by the lifting grill (53), in particular the outermost support bars (55), on mutually facing sides.

66. Computer-controlled conveyor system according to claim 61, wherein the lifting frame (46) has two freely projecting support arms (70) between which the lifting grill (53) is disposed, and the lifting grill (53) with its outermost support bars (55) bounds the orifices (47) separated from one another by the lifting grill (53) on mutually facing sides and incorporates the depositing area for the storage aid (30).

67. Computer-controlled conveyor system according to claim 61, wherein the lifting grill (53) forms one or both orifices (47), and its respectively adjacent support bars (55) and part-sections of its peripherally extending frame bound the orifices (47) on all sides.

68. Computer-controlled conveyor system according to claim 37, wherein a support frame (40) incorporating the horizontal support surface (31) formed by it for the storage aid (30) is disposed on the lifting platform (5) and comprises several parallel support surfaces (41) lying in a single plane spaced at a distance apart, which form the depositing area, and the distance between adjacent support surfaces (41) is slightly bigger than the width of the support bars (55).

69. Computer-controlled conveyor system according to claim 37, wherein a longitudinal conveyor system (66) is disposed between the two telescopic pushing arms (33) extending parallel with their longitudinal extension, comprising at least one endless conveyor (67) and forming the support surface (31).

70. Computer-controlled conveyor system according to claim 37, wherein the lifting platform (5) and holding table (6) can be positioned relative to a stowage or retrieval point in the upstream zone at the end of a shelf aisle (2) for the conveyor system, and the lifting platform (5) is retained in a desired position pre-defined by a computer system, and the holding table (6) is retained at a fixed distance relative to the lifting platform (5), and a filling and pick-up system disposed in the upstream zone co-operates with the first storage aid (30) deposited on the holding table (6), and the load bearing mechanism (32) co-operates with the second storage aid (30) deposited on the lifting platform (5).
